(19) United States
(12) Patent Application Publication
(10) Pub. No.: US 2026/0203690 A1
(43) Pub. Date: Jul. 16, 2026

(54) System and Methods for Automating Project Requirements Management Support Documentation

(71) Applicant: Charter Communications Operating, LLC, St. Louis, MO (US)

(72) Inventors: Susan DAVIS, St. Peters, MO (US); Saravanapandian GANESAPANDIAN, Frontenac, MO (US); Traci STEO, St. Louis, MO (US)

(21) Appl. No.: 19/016,051

(22) Filed: Jan. 10, 2025

(51) Int. Cl. G06Q 10/0631; G06F 40/40

(52) U.S. Cl. CPC G06Q 10/06316; G06F 40/40

(57) ABSTRACT

Disclosed are artificial intelligence-driven system and methods for generating project requirements management documentation. A large language model (LLM) AI system receives input project requirements, including business requirements, process flows, and use cases, and analyzes the data to generate elicitation questions. Responses to the questions are processed to create epics, features, and user stories. Acceptance criteria are generated for the user stories, defining completion conditions. Based on the structured documentation, the computing system generates to-be process flows adhering to process modeling standards and test cases with detailed instructions, input conditions, expected outcomes, and pass/fail criteria. The documentation is outputted to an analyst for review via an interface and uploaded to a project requirements management repository, such as JIRA®, ensuring traceability from business requirements to test cases. The computing system's training and iterative learning enable continuous adaptation to evolving project requirements management standards and workflows, reducing manual effort and improving documentation accuracy.

### BACKGROUND

In related project requirements management workflows, analysts play a critical role in generating the documentation necessary to guide and track the progress of a project. This project requirements management workflow process typically begins with the gathering business requirements in various formats, such as written statements, process flows, and use cases, and then analyzing and organizing these inputs to produce elicitation questions. The elicitation sessions that follow allow analysts to collect additional details, which are then transformed into structured project documentation, including epics, user stories, acceptance criteria, process flows, and test cases. Each of these documents must be prepared to ensure that they align with project goals, meet stakeholder requirements, and provide clear guidance to development and testing teams. However, this process is time-consuming and labor-intensive, requiring analysts to manually interpret, synthesize, and format diverse inputs while maintaining traceability and adherence to standards. Although this documentation is important for efficient and agile project management, enabling teams to coordinate effectively and deliver high-quality results, the preparation of this documentation often involves repetitive and tedious tasks that can detract from higher-value analytical and strategic activities.

### SUMMARY

Various aspects include methods—and computing systems implementing embodiment methods—for automating the generation of requirements management documents, process flows, and acceptance criteria, including quality and standard checks. Various aspects may include receiving as an input project requirements for a project, applying the project requirements to a first large language model (LLM) that is trained or fine-tuned to generate elicitation questions in response to project requirements and output elicitation questions generated by the LLM, applying answers to elicitation questions to a second LLM that is trained or fine-tuned to generate epics, features, and user stories in response to elicitation question answers and output epics, features, and user stories generated by the LLM, applying finalized user stories to a third LLM that is trained or fine-tuned to generate acceptance criteria in response to finalized user stories and output acceptance generated by the LLM, the acceptance criteria defining conditions under which the user stories may be considered complete, applying finalized acceptance criteria to a fourth LLM that is trained or fine-tuned to generate to-be process flows in response to finalized acceptance criteria and output to-be process flows generated by the LLM, applying finalized to-be process flows to a fifth LLM that is trained or fine-tuned to generate test cases in response to finalized to-be process flows and output test cases generated by the LLM; and automatically uploading to a project requirements management system the epics, features, finalized user stories, finalized acceptance criteria, to-be process flows, and finalized test cases. In various aspects, the input project requirements may be received via a direct upload, accessed from a database or repository, or retrieved from a specified Uniform Resource Locator (URL).

In some aspects, applying the project requirements to a first LLM may include applying both the input project requirements and standardized requirements retrieved from a repository to the first LLM to generate the elicitation questions.

In some aspects the second LLM is trained or fine-tuned to generate user stories that specify an actor, action, and outcome. In some aspects the third LLM is trained or fine-tuned to generate acceptance criteria that adhere to at least one of INVEST or SMART principles. In some aspects the fourth LLM is trained or fine-tuned to generate to-be process flow that comply with Business Process Model and Notation (BPMN) 2.0 standards. In some aspects the fifth LLM is trained or fine-tuned to generate test cases that include scenarios covering at least positive, negative, and alternate pathways. In some aspects, the first LLM, second LLM, third LLM, fourth LLM, and fifth LLM may be trained inference functionality within a single overall LLM.

In some aspects, automatically uploading to a project requirements management system the epics, features, finalized user stories, finalized acceptance criteria, to-be process flows, and finalized test cases may include uploading the documentation to a JIRA® repository.

Some aspects may further include performing adaptive learning processes on one or more of the first LLM, second LLM, third LLM, fourth LLM, and fifth LLM over time based on use of an artificial intelligence (AI) LLM computing system to adapt to changes in project requirements management practices, document formats, or business processes. Some aspects may further include logging generated documentation with traceability to the input project requirements.

Further aspects may include a computing device having a processing system configured with processor-executable instructions to perform operations corresponding to any of the methods summarized above. Further aspects may include a non-transitory processor-readable storage medium having stored thereon processor-executable instructions configured to cause a processing system to perform operations corresponding to any of the methods summarized above. Further aspects may include a computing device having various means for performing functions corresponding to any of the method operations summarized above.

### BRIEF DESCRIPTION OF THE DRAWINGS

The accompanying drawings, which are incorporated herein and constitute part of this specification, illustrate exemplary embodiments of the claims, and, together with the general description given and the detailed description, serve to explain the features herein.

FIGS. 1A-1C are a flow diagram of actions and operations performed by a trained LLM AI computing system and an analyst's use of the computing system to generate project requirements management documentation according to various embodiments.

FIGS. 1D and 1E are example portions of project requirements management documents that may be generated according to various embodiments.

FIG. 2A is a notional block diagram illustrating elements of an artificial neural network processing system.

FIGS. 2B and 2C are notional block diagrams illustrating elements and methods of training a neural network using a training dataset.

FIG. 3 is a block diagram illustrating processing modules, connected memory, and computing devices of an AI LLM computing system suitable for implementing various embodiments.

FIG. 4 is a block diagram of an example system illustrating hardware and functional modules suitable for implementing various embodiments.

FIG. 5 is a process flow diagram illustrating a computer system method for generating project requirements management documentation according to various embodiments.

FIG. 6 is a component diagram of an example computing system suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include an automated computing system that includes specially trained or fine-tuned large language model (LLM) processing capabilities designed to streamline and enhance the process of generating project requirements management documentation. In various embodiments, the computing system may receive business requirements package including but not limited to business requirements, as is process flows, use cases, etc. as an input and use a specially trained or fine-tuned LLM to generate a list of elicitation questions that are designed to clarify and refine the requirements. Answers to the elicitation questions may be input to the computing system, which applies the answers to an LLM trained to produce draft epics, features, and user stories that articulate functional goals. The user stories may be edited by an analyst to align with project objectives, with the revised user stories input into the computing system. The computing system applies the revised user stories to an LLM trained to generate and output draft acceptance criteria for the user stories that adhere to enterprise policies and industry standards, including the INVEST (independent, negotiable, valuable, small, testable) principles for writing effective user stories and SMART (specific, measurable, achievable, relevant, time-bound) principles.

The computing system may receive finalized acceptance criteria and apply them to an LLM trained to produce to-be process flow diagrams compliant with enterprise templates and industry standards, such as the BPMN (business process model and notation) 2.0 methodology. Such to-be process flows may be output to an analyst who may review and input refined to-be process flows to the computing system. The computing system may apply the refined to-be process flows to an LLM that is trained to generate and output test cases. Once the user stories are finalized by an analyst and re-input to the computing system, the computing system may apply the user stories to an LLM that is trained to generate and output functional test cases with traceability to the acceptance criteria. The computing system may then automatically upload finalized versions of the epics, features, user stories, acceptance criteria, to-be process flows, and test cases to a project requirements management system for use by the project team and other stakeholders. This end-to-end automation of processes of generating project requirements management documents reduces manual efforts, enhances consistency, and improves the efficiency of project initiation and planning workflows.

The term “computing system” is used herein to refer to (but not limited to) any one or all of servers, workstations, desktop computers, laptop computers, and other similar computing systems that include a memory for storing documents and neural network computational data, and a programmable processing system that may be configured to provide the functionality of various embodiments. The processing system may include neural network processors, such as graphical processing units, and neural network memory modules for running specialized LLM AI modules trained or fine-tuned according to various embodiments.

The term “computing device” is used herein to refer to any computer that may connect to or interface with the computing system, such as desktop computers, laptops, or mobile devices used by analysts for interfacing with a computing system according to various embodiments.

The term “processing system” is used herein to refer to one or more processors, including multi-core processors, graphics processing units (GPU), neural network processing units (NPU), microprocessor units (MPU), arithmetic logic units (ALU), memory systems, etc., that are organized and configured to perform computing functions of various embodiments, including executing specialized LLM AI models for generating project requirements management documents as described herein.

The terms “neural network” and “neural network model” are used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results.

After the training process is complete, the neural network may operate in an “inference” mode in which inputs (sometimes referred to as “prompts”) are processed as new tasks with the determined weights. The term “inference” is used herein to refer to a process that is performed at runtime or during the execution of the software application program corresponding to the neural network. Inferences may be generated by inputs traversing the processing nodes in the neural network along a forward path to produce one or more values as an overall activation or overall “inference result.”

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in between the input and final layer may be referred to as intermediate layers, hidden layers, or black-box layers.

Each layer in a neural network may have multiple inputs and, thus multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer and multiple preceding layers.

Recurrent neural networks” (RNN) are a class of neural networks particularly well-suited for sequence data processing. Unlike feedforward neural networks, RNNs may include cycles or loops within the network that allow information to persist. This enables RNNs to maintain a “memory” of previous inputs in the sequence, which may be beneficial for tasks in which temporal dynamics and the contexts in which data appears are relevant.

Long short-term memory networks (LSTM) are a type of RNN that addresses some of the limitations of basic RNNs, particularly the vanishing gradient problem. LSTMs include a more complex recurrent unit that allows for the easier flow of gradients during backpropagation. This facilitates the model's ability to learn from datasets that include large files (e.g., project requirements management documentation) and remember over multiple data file inputs, making it apt for tasks such as continuous machine learning based on updates that include many large data files as may be generated during the project requirements management document development process at project initiation.

Many neural network models or machine learning systems use a transformer architecture, which is a specific type of neural network that includes an encoder and/or a decoder and is particularly well-suited for sequence data processing. Transformers may use multiple self-attention components to process input data in parallel rather than sequentially. The self-attention components may be configured to weigh different parts of an input sequence when producing an output sequence. Unlike solutions that focus on the relationship between elements in two different sequences, self-attention components may operate on a single input sequence.

The self-attention components may compute a weighted sum of all positions in the input sequence for each position, which may allow the model to consider other parts of the sequence when encoding each element. This may offer advantages in tasks that benefit from understanding the contextual relationships between elements in a sequence, such as sentence completion, translation, and summarization. The weights may be learned during the training phase, allowing the model to focus on the most contextually relevant parts of the input for the task at hand. Transformers, with their specialized architecture for handling sequence data and their capacity for parallel computation, often serve as foundational elements in constructing large generative AI models (LXM).

Large generative AI models (LXM) are an advanced computational framework that includes any of a variety of specialized AI models including, but not limited to, large language models (LLMs), large speech models (LSMs), large/language vision models (LVMs), vision language models (VLMs)), hybrid models, and multi-modal models. An LXM may include multiple layers of neural networks (e.g., RNN, LSTM, transformer, etc.) with millions or billions of parameters.

In various embodiments, LXMs may operate independently as standalone units, may be integrated into more comprehensive systems and/or into other computational units and/or may interface with specialized hardware accelerators to improve performance metrics such as latency and throughput. In some embodiments, a LXM component may be enhanced with or configured to perform an adaptive algorithm that allows the LXM to better understand context information and perform operations in support of an overall analysis process. In some embodiments, the adaptive algorithms may be performed by the same processing system that manages the core functionality of the LXM and/or may be distributed across multiple independent processing systems.

The term “embedding layer” is used herein to refer to a specialized layer within a neural network, typically at the input stage, that transforms discrete categorical values or tokens into continuous, high-dimensional vectors. An embedding layer may operate as a lookup table in which each unique token or category is mapped to a point in a continuous vector space. The vectors may be refined during the model's training phase to encapsulate the characteristics or attributes of the tokens in a manner that is conducive to the tasks the model is configured to perform.

The term “token” is used herein to refer to a unit of information that a generative neural network may receive as a single input during training and inference. Each token may represent any of a variety of different data types. For example, in LLMs, tokens may be associated with small words and parts of words, thereby transforming words and sentences into sequences of numbers that can be used in mathematical calculations, such as multiplication and threshold comparisons. In hybrid systems that combine multiple modalities (text, drawings, formulas, etc.), each token may be a complex data structure that encapsulates information from various sources.

Each token may be converted into a numerical vector via the embedding layer. Each vector component (e.g., numerical value, parameter, etc.) may encode an attribute, quality, or characteristic of the original token. The vector components may be adjustable parameters that are iteratively refined during the model training phase to improve the model's performance during subsequent operational phases. The numerical vectors may be high-dimensional space vectors (e.g., containing more than 300 dimensions, etc.) in which each dimension in the vector captures a unique attribute, quality, or characteristic of the token. Such intricate representations in high-dimensional space may help the trained neural network “understand” the context and interrelationships between various project requirements management documentation in the training datasets.

During operational or inference usage, the tokens may be processed sequentially through layers of the trained neural network, which may include structures or networks appropriate for sequence data processing, such as transformer architectures, recurrent neural networks (RNNs), or long short-term memory networks (LSTMs).

The term “sequence data processing” is used herein to refer to techniques or technologies for handling ordered sets of tokens in a manner that preserves their original sequential relationships (e.g., words, sentences, paragraphs, and sections of documents) and captures dependencies between various elements within the sequence. The resulting output may be a probabilistic distribution or a set of probability values, each corresponding to a “possible succeeding token” in the existing sequence. The trained neural network may choose the token with the highest determined probability value to identify subsequent words to use in generating a document, which may subsequently be fed back into the model for further language analysis or generation.

The term “adaptive learning” is used herein to refer to processes for continuously updating LLM model parameters based on new data received during usage of the model. Adaptive learning processes involve incrementally adjusting model parameters using algorithms designed to integrate new information without requiring retraining on an entire training dataset. By dynamically incorporating data from real-time interactions or changing requirements, the AI LLM computing system can adapt to evolving patterns, requirements, formats, and policies, ensuring its outputs remain accurate and relevant and thus improve over time.

Various embodiments include an LLM AI computing system that is specially trained or fine-tuned to perform a series of operations to transform project requirements into structured and actionable project requirements management documentation. Use of the computing system begins with the input of project requirements, which may include business requirements, process flows, use cases, or other related documents. These inputs can be directly uploaded into the computing system by an analyst, retrieved from a repository or database, and/or accessed via a URL. Leveraging its training on project requirements management standards and methodologies, the LLM AI computing system processes the input requirements to generate a set of elicitation questions. These questions are designed to be answered by project participants and stakeholders to identify additional details, both functional and non-functional, necessary to refine the project's requirements.

Once the elicitation process is complete, the LLM AI computing system receives the elicitation responses, such as answers and clarifications provided during sessions with stakeholders, and applies this information to an LLM trained or fine-tuned to generate high-level project elements, including epics, features, and user stories. User stories may be structured in a format commonly used in Agile project management, specifying the actor, action, and expected outcome. These user stories serve as a foundation for subsequent project requirements management documents. The LLM AI computing system may apply finalized user stories to an LLM that is trained to generate acceptance criteria for each user story, such as acceptance criteria conforming to established standards, such as INVEST and SMART principles. The acceptance criteria may provide testable conditions that must be met for each user story to be considered complete.

The computing system then apply finalized acceptance criteria, as well as the epics, features, and user stories, to an LLM trained or fine-tuned to generate to-be process flows. Such to-be process flows represent the desired future state of the project's workflows and provide stakeholders and project teams with a clear understanding of how the project's objectives will be achieved. These process flows may adhere to established process modeling standards such as BPMN 2.0.

The to-be process flows may be reviewed and approved, after which the computing system may use an LLM that is trained or fine-tuned to generate test cases based on the approved acceptance criteria and process flows. Each test case may include detailed instructions, input conditions, expected outcomes, pass/fail criteria and traceability to the acceptance criteria, ensuring thorough validation of the project deliverables. The test cases may cover positive, negative, and alternate scenarios, providing comprehensive coverage of all functional and non-functional requirements.

Finally, the computing system may automate the upload of generated test cases along with to be process flows and user stories with acceptance criteria, as well as the previously created documentation, into a project requirements management system repository or database, such as a JIRA® repository, to ensure traceability and accessibility for all project stakeholders. By integrating and automating these operations, the computing system significantly reduces the manual effort involved in project documentation, improves consistency, and enhances collaboration across teams.

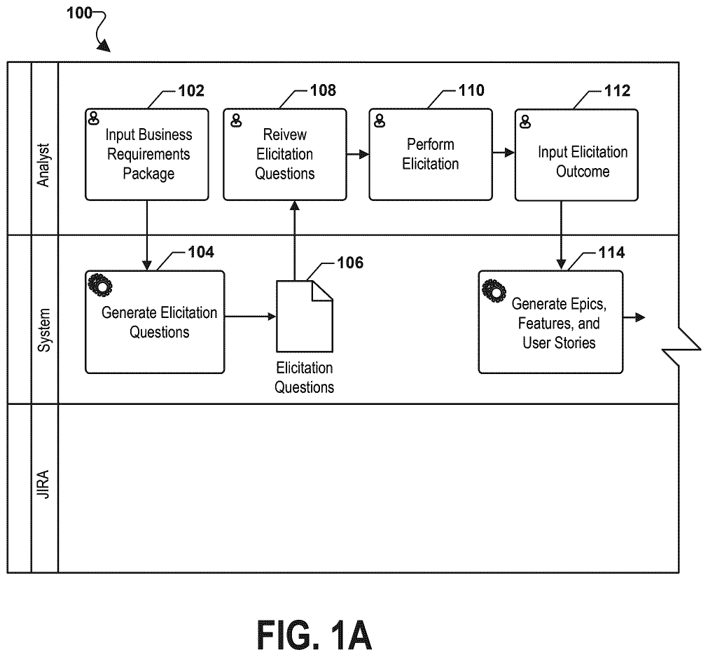

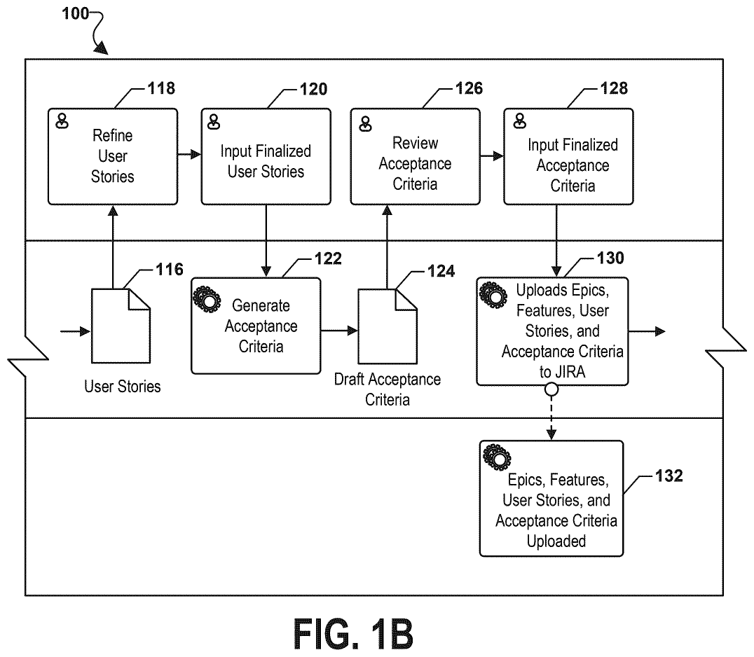

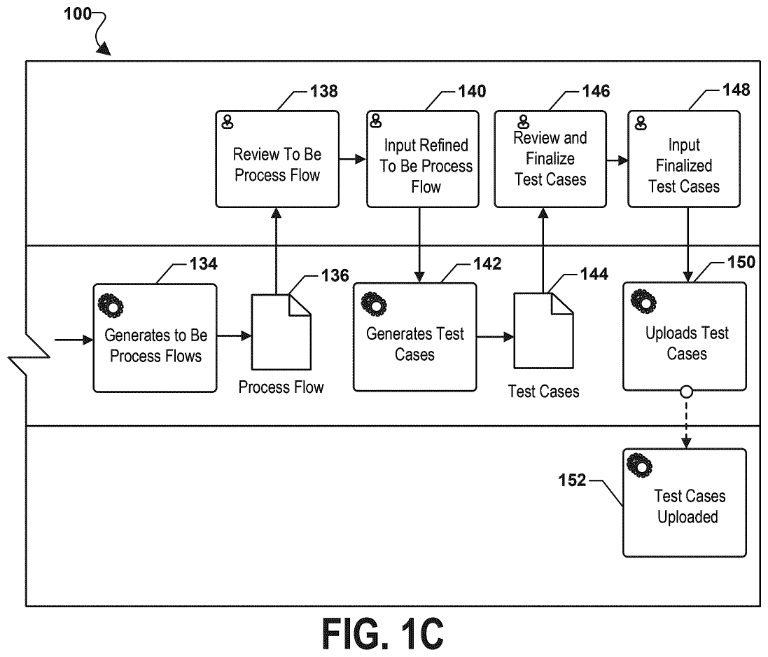

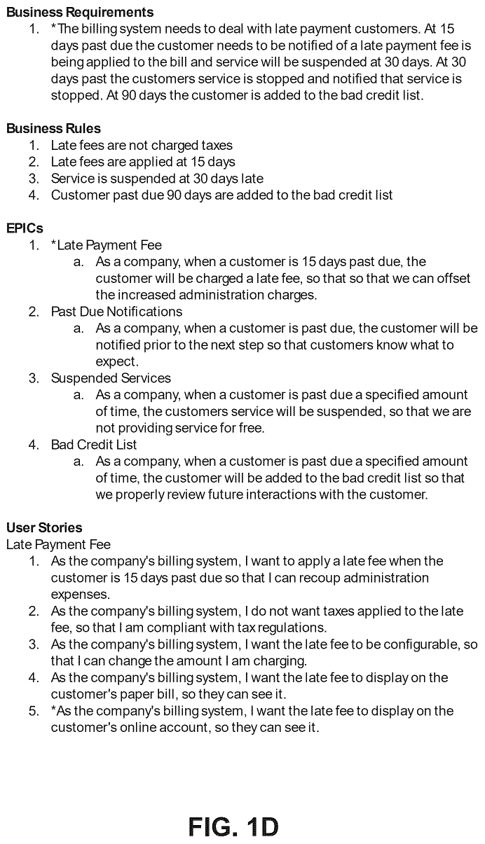

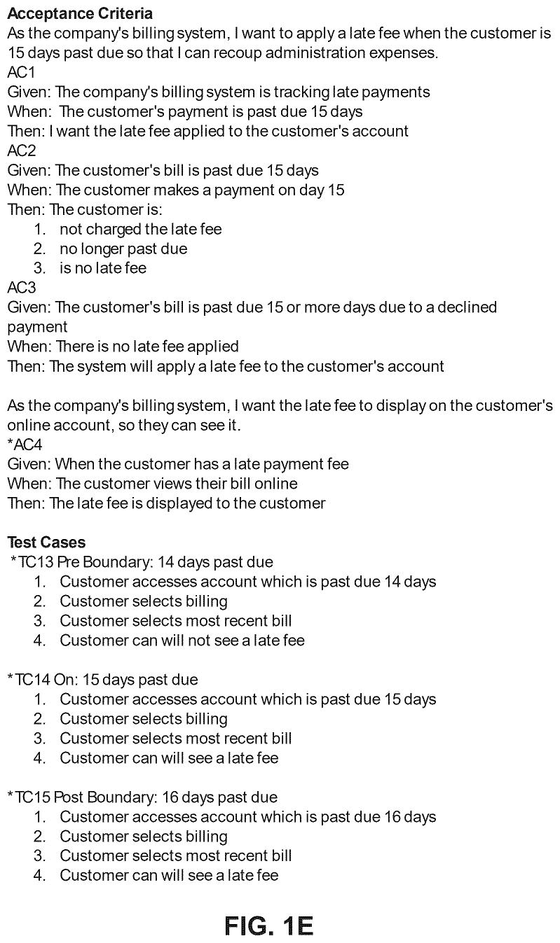

FIGS. 1A to 1C provide a process flow diagram 100 that graphically illustrate the actions of an analyst using the LLM AI computing system and the operations performed by the computing system in response. In describing these figures, references to “the computing system” are intended to encompass a computer, server, or system of computing devices that include neural network processing capabilities configured with large language models (LLM) that are specifically trained, fine-tuned and/or improved through adaptive learning to generate project requirements management documentation as described herein. In some embodiments, the computing system may include and execute multiple LLMs that are each specially trained or fine-tuned to produce a particular set of documents in response to a given input, such as output elicitation questions based on inputs of project requirements. In some embodiments, the computing system may include and execute an overall LLM that has been trained or fine-tuned with various inference functionality to receive the various inputs described herein and output the various project documents. To address these two LLM architecture options, references are made to multiple LLMs or portions of an overall LLM.

Referring to FIG. 1A, in block 100, a project requirements management document generation process may begin in block 102 with an analyst inputting into the computing system business requirements, which may include documents such as business rules, process flows, and use cases. An analyst may provide these requirements documents via upload, repository access, and/or by specifying a URL for a network location where the documents may be obtained.

In block 104, the computing system processes the input requirements in an LLM that is trained or fine-tuned to generate elicitation questions. These questions are written to be used by the analyst to uncover additional details needed for refining the project scope and requirements. Specifically, the computing system may apply the requirements in one or more prompts to an LLM or a portion of an overall LLM that has been trained or fine-tuned to infer and output elicitation questions based on or in response to business requirements.

In block 106, the elicitation questions are outputted to the analyst for review and refinement. Such outputs may be in the form of a display on a user interface, printed file or files, and/or documents or files stored in memory accessible by the analyst.

In block 108, the analyst may review and refine the elicitation questions, and in block 110, the analyst conducts elicitation sessions using the generated questions to gather detailed responses from project team members and stakeholders. By putting the elicitation questions to members of a project team and stakeholders of the project (e.g., in person sessions or via electronic communications), the analyst may learn and record further requirements and information useful for developing project requirements management documentation.

In block 112, the analyst inputs the responses to the elicitation questions into the computing system. Such inputs may be in the form of a transcript of discussions with the project team, a report or documentation of responses, or in direct user inputs of responses to posed questions, such as in the form of a query-and-response user interface that can be used by the analyst or directly by project team members and stakeholders.

In block 114, the computing system uses the elicitation responses to generate epics, features, and user stories, creating a structured hierarchy of project objectives and tasks. Specifically, the computing system may apply the responses in one or more prompts to an LLM or a portion of an overall LLM model that has been trained or fine-tuned to infer and output epics, features, and user stories based on or in response to elicitation responses.

In the context of Agile project requirements management documentation, the term “epics” refers to high-level, overarching features or objectives that represent a significant body of work within the project. Epics are typically composed of smaller, more detailed user stories that collectively define the requirements and tasks needed to achieve the functionality or goal described by the epic.

In Agile project requirements management, “user stories” are concise, detailed descriptions of specific functionality or tasks that are derived from broader objectives, such as epics. Each user story defines a particular requirement from the perspective of an end-user, typically including information about the desired outcome, purpose, and acceptance criteria necessary to complete the task.

Referring to FIG. 1B, in block 116, the computing system outputs the generated epics, features, and user stories to the analyst for review and approval. Such outputs may be in the form of a display on a user interface, printed file or files, and/or documents or files stored in memory accessible by the analyst.

In block 118, the analyst may review and refine the epics, features, and user stories output by the computing system and make changes and refinements. The analyst may input finalized user stories into the computing system in block 120.

In block 122, the computing system generates draft acceptance criteria for the user stories based on the refined user stories. In the context of user stories, “acceptance criteria” are specific conditions or requirements that should be met for the user story to be considered complete and acceptable to stakeholders. These criteria serve as a benchmark for functionality and quality, helping to ensure that the completed project aligns with the intended purpose and satisfies the end-user's needs. In block 122, the computing system may apply the refined user stories in one or more prompts to an LLM or a portion of an overall LLM model that has been trained or fine-tuned to infer and output acceptance criteria that align with project goals and standards.

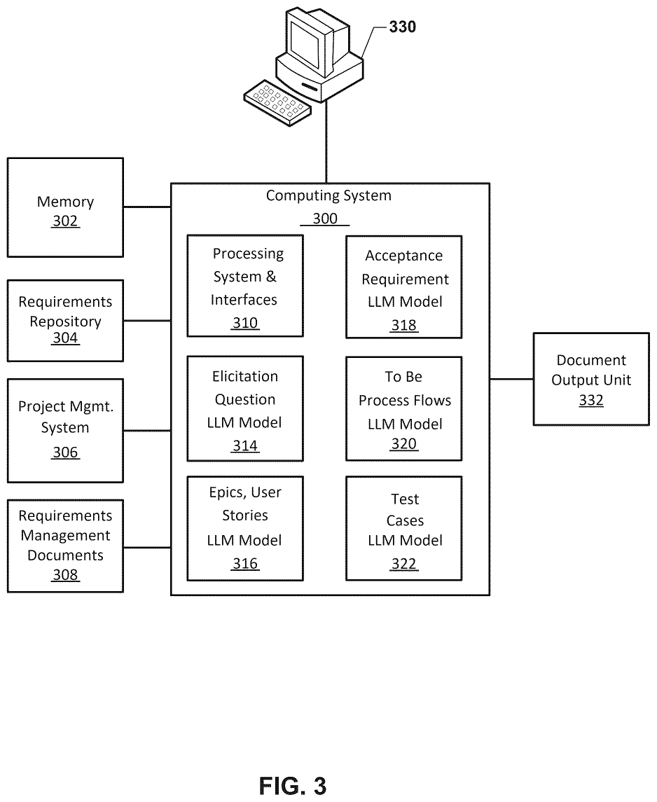

In some embodiments, the LLM (or portions of an overall LLM) may be trained and/or fine-tuned to also access enterprise guidelines, standards, and policies, such as may be stored in a database (e.g., a requirements repository 304 shown in FIG. 3), to integrate both project-specific requirements and overall enterprise, legal, and technical standards/policies into the generated draft acceptance criteria.

In block 124, the computing system outputs the draft acceptance criteria to the analyst for review and refinement. As with other outputs, the draft acceptance criteria may be output in the form of a display on a user interface, a printed file or files, and/or documents or files stored in memory accessible by the analyst.

In block 126, the analyst may review and refine the draft acceptance criteria output by the computing system and may make changes and refinements. Additionally, project requirements management acceptance criteria may be reviewed and refined by the project team or others (e.g., a greybeard review team) to arrive at finalized acceptance criteria. Then in block 128, the analyst inputs the finalized acceptance criteria into the computing system.

In block 130, the computing system uploads the finalized epics, features, user stories, and acceptance criteria into a project requirements management system block 132, such as a JIRA® repository. JIRA® is a software tool developed by Atlassian that is commonly used for issue tracking, project requirements management, and as a platform for managing software development processes, including Agile workflows. The outcome of this process is a well-structured repository in JIRA, ensuring all project elements are accessible by project team members and aligned with stakeholder requirements. By automating this upload of completed project requirements management documents, the computing system further reduces the tasks performed by the analyst, improving efficiency and reducing the time required to prepare project requirements management documentation.

Referring to FIG. 1C, in block 134, the computing system uses some or all of the requirements and generated project documents to generate to-be process flows based on the finalized epics, features, and user stories. As part of the operations in block 134, the computing system may apply the requirements and project requirements management documents generated so far in one or more prompts to an LLM or a portion of an overall LLM model that has been trained or fine-tuned to infer and output to-be process flows.

“To-be process flows” are graphical representations that describe the desired future state of a project or workflow in Agile project requirements management. These process flows include the sequence of tasks, decision points, inputs, and outputs required to complete a feature or user story. Each process flow identifies the responsible entities, such as teams or systems, and incorporates dependencies or parallel processes where applicable. By mapping the logical progression of tasks and identifying critical paths, the to-be process flows provide a structured framework for implementing the project deliverables. These process flows represent the desired future state of the workflows and translate high-level requirements (e.g., epics and user stories) into actionable workflows that are easily understood by development teams and stakeholders.

In block 136, the computing system outputs the to-be process flows to the analyst for review and refinement. As with other outputs, the to-be process flows may be output in the form of a display on a user interface, a printed file or files, and/or documents or files stored in memory accessible by the analyst.

In block 138, the analyst reviews and refines the to-be process flows, and then inputs refined to-be process flows into the computing system in block 140.

In block 142, the computing system uses the refined to-be process flows and the refined acceptance criteria to generate test cases. As part of the operations in block 142, the computing system may apply the refined to-be process flows and the refined acceptance criteria in one or more prompts to an LLM or a portion of an overall LLM model that has been trained or fine-tuned to infer and output test cases. By analyzing the tasks, decision points, and dependencies represented in the process flows, the LLM may identify specific scenarios and pathways that require validation to ensure that the process operates as intended. The trained LLM may map each step or decision in the to-be process flows to corresponding input conditions, expected outcomes, and validation criteria. Also, the computing system may incorporate the acceptance criteria associated with the user stories into the test cases addressing all functional and non-functional requirements, such as performance, security, and usability.

Test cases play an important role in Agile project requirements management by ensuring that project deliverables meet the defined requirements and functions of a project. Test cases provide a structured approach to verifying the correctness, completeness, and quality of features or functionalities at various stages of the project. Test cases enable iterative validation during a project, allowing teams to identify and resolve defects early in the development cycle, which reduces the cost and effort of later corrections. By providing a clear link between requirements and validation, test cases enhance transparency, facilitate collaboration among stakeholders, and ensure that the final deliverables align with business objectives and user needs.

In block 144, the generated test cases are output to the analyst for review and refinement. As with other outputs, the to-be process flows may be output in the form of a display on a user interface, a printed file or files, and/or documents or files stored in memory accessible by the analyst.

In block 146, the analyst reviews and finalizes the test cases, and in block 148, inputs the finalized test cases into the computing system.

In block 150, the computing system uploads the finalized test cases into the project requirements management system, such as a JIRA® repository (block 152) for access by project team members and stakeholder. By automating this upload, the computing system further reduces the tasks performed by the analyst, improving efficiency and reducing the time required to prepare project requirements management documentation.

The information included in this upload may include information linking the test cases to the corresponding project requirements documentation to maintain and facilitate traceability. The resulting project requirements management documentation provides a fully integrated repository of project requirements management documentation, including traceability from the initial requirements to the final test cases.

FIGS. 1D and 1E provide some non-limiting example portions of project requirements management documents that may be generated using the computing system of various embodiments. Specifically, FIG. 1D lists an example business requirement and example business rules that may be imposed on a billing system revision project, and examples of some of the epics and user stories that may be generated by the computing system for this project requirements management. FIG. 1E lists example portions of acceptance criteria and test cases for the project that are based on the project requirements, rules, epics and user stories shown in FIG. 1D.

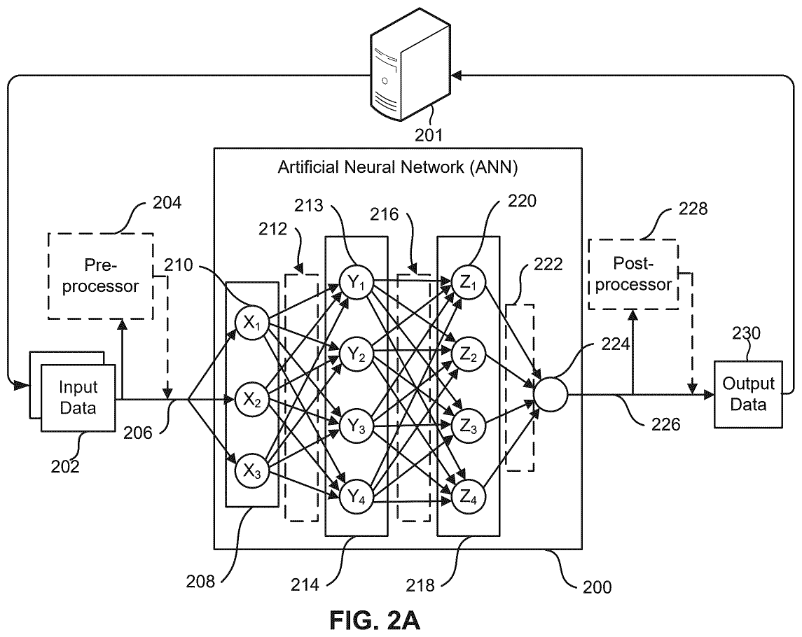

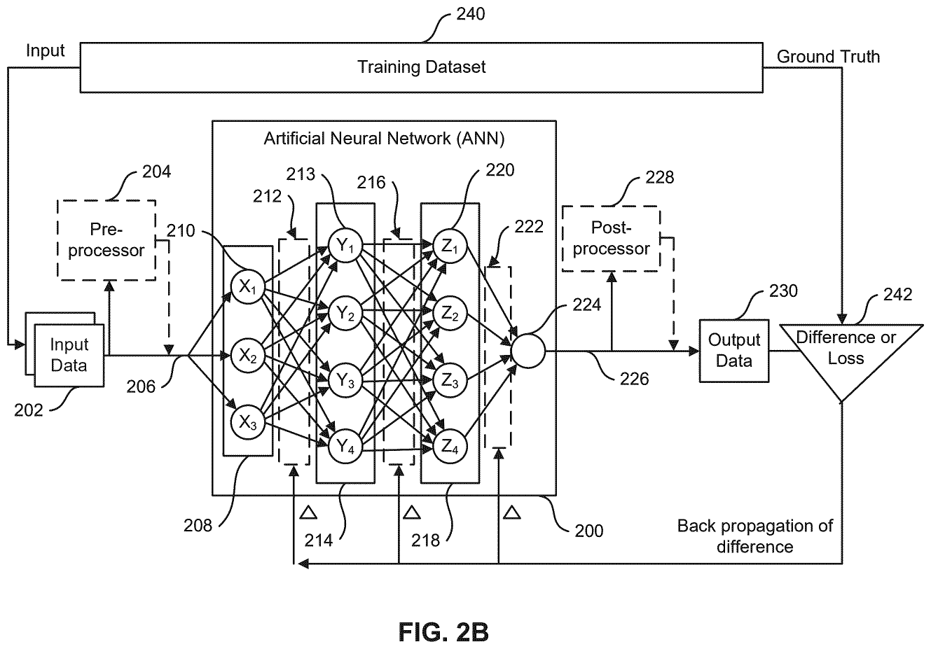

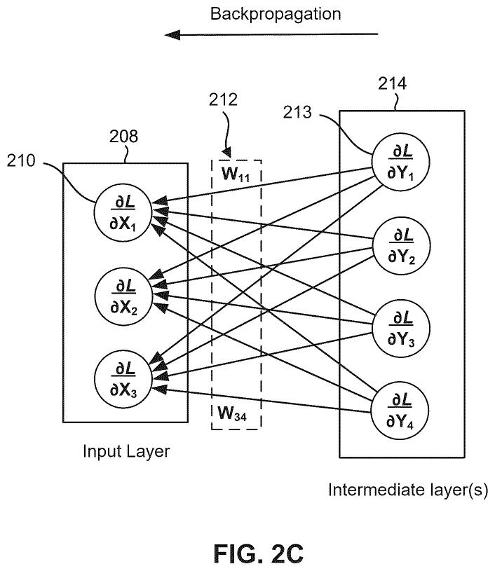

Referring to FIG. 2A, a neural network 200 for use in various embodiments may include an input layer 208, intermediate layer(s) 214, 218, and an output layer 224. Each of the layers 208, 214, 218, 224 may include one or more processing nodes 210, 213, 220 (labeled as X₁-X₃, Y₁-Y₄, and Z₁-Z₄) that receive input values, perform computations based on the input values and weights 212, 216, 222, and propagate the result (referred to as “activations”) to the next layer (illustrated as arrows).

Artificial neurons 210, 216, 220, 224 in each layer 208, 214, 218, 224 may be activated by or be responsive to parameters, such as the weights and biases 212, 216, 222 of the neural network 200. The weights and biases of the neural network 200 are adjusted during a training process to control the strength of connections between layers 208, 214, 218, 224 or artificial neurons 210, 216, 220, 224, while the biases 212, 216, 222 control the direction of connections between the layers or artificial neurons. An activation function may select or determine whether an artificial neuron 210, 216, 220, 224 transmits its output to the next layer or not in response to its received data.

In feed-forward neural networks, such as the neural network 200 illustrated in FIG. 2A, the computations are performed as a sequence of operations on the outputs of a previous layer (e.g., 208, 214, 218). The final set of operations generates the output 224 of the neural network, such as a sentences and paragraphs to include in a generated document. Many neural networks 200 are stateless.

The neural network 200 illustrated in FIG. 2A includes fully-connected (FC) layers 208, 214, 218, 224, which are also sometimes referred to as multi-layer perceptrons (MLPs). In a fully-connected layer 208, 214, 218, 224, all outputs are connected to all inputs (illustrated by arrows). Each processing node's activation is computed as a weighted sum of all the inputs received from the previous layer based on weights 212, 216, 222.

Referring to layers 208 and 214 in FIG. 2A, an example computation performed by the processing nodes and/or neural network 200 may be: yⱼ=f(Σ³ᵢ₌₁ Wᵢⱼ*xᵢ+b), in which Wᵢⱼ are weights (illustrated as matrix 212), xᵢ is the input to the layer, yⱼ is the output activation of the layer, f(•) is a non-linear function, and b is bias. At a subsequent layer, these features may be combined to indicate the likely presence of higher-level features, such as the context of text being generated.

As illustrated in FIG. 2A, a neural network 200 may be supplemented by pre-processing of input data 202 (e.g., project requirements) and post-processing of an inference output 226 of the neural network to facilitate the generation of useful output data 230 in the form of project requirements management documents, such as according to a specific document format. For example, project requirements in no particular format may be pre-processed by a pre-processor 204, such as to organize, reformat, or otherwise transform raw requirements into a format suitable for use in a transformer that converts the inputs into tokens that can be used as an input 206 to the first layer 208. Similarly, the output 226 of the neural network output layer 224 may be post-processed by a post-processor 228 to translate, reformat, or otherwise transform the inference into output data 230 in the form of project requirements management documents according to predefined formats.

FIG. 2B is a notional block diagram of a neural network 200 illustrating the training process. A neural network 200 for use in various embodiments may be trained on project requirements management documentation and the processes of generating such documentation. The overall structure of the neural network 200, and operations of the processing nodes and layers 208, 214, 218, 224 do not change as the neural network learns the task. Rather, the training process adjusts the values of the weights and biases of each layer so that the correct output inference 226 is produced for a given input 206.

Training the neural network 200 may include causing the neural network 200 to process a training or previously acquired set of project requirements and other document inputs, referred to as a training dataset, for which an expected/desired output in the form of project requirement management documents is known (such as documentation from previous project requirement management efforts). This training dataset provides the ground truth for the inference that the neural network should produce from processing the training dataset. An error or difference can be determined by comparing the output generated by the neural network 200 to the expected/desired output (i.e., ground truth). This difference between the ground truth output and the output generated by the neural network 200 is referred to as loss (L) or difference.

To train a neural network 200, the training dataset 240 is used to provide the input data 202 that is processed by the neural network. In the training process, the neural network 200 receives a set of training input data, performs calculations through the various network layers 208, 214, 218, 224 by applying biases and weights 212, 216, 222 to produce an output 226 or output data 230. The output 226 or output data 230 is compared to the ground truth associated with the corresponding input data 202 to calculate a difference or loss 242. This difference or loss is then provided in a backpropagation process to the layers and weights in the neural network to provide feedback that is used to adjust the biases and weights of the neural network so as to reduce the difference or loss.

Backpropagation may operate by passing values backward through the neural network 200 to compute how the loss is affected by each weight between each layer. The backpropagation computations may be similar to the computations used when traversing the neural network 200 in the forward direction (i.e., during inference). To improve performance, the difference or loss (L) from multiple sets of input data (“a batch”) may be collected and used in a single pass for updating the weights in the neural network. Many passes may be required to train the neural network 200 with weights suitable for use during inference operations for generating project requirement management documents according to predefined formats.

Referring to FIG. 2C, during training, the weights (Wᵢⱼ) may be updated using a hill-climbing optimization process called “gradient descent.” The gradient indicates how the weights should change in order to reduce the difference or loss (L). In the backpropagation computations, various weights may be adjusted based upon the relative contribution to the difference of each weight, sometimes referred to the gradient effect of each weight. This gradient indicates how the weights should change in order to reduce the difference or loss (L). A multiple of the gradient of the loss relative to each weight, which may be the partial derivative of the difference or loss L with respect to the weight

$$( e . g . , \frac{\partial L}{\partial {X}_{1}} , \frac{\partial L}{\partial {X}_{2}} , \frac{\partial L}{\partial {X}_{3}} ) ,$$

could be used to update the weights 212, 216, 222.

Different activation functions may be used to model different types of non-linear relationships. By introducing non-linearity into a machine learning neural network model, an activation function allows the configuration for the machine learning neural network model to change in response to identifying or detecting complex patterns and relationships in the input data 202. Some non-limiting activation functions include a sigmoid-based activation function, a hyperbolic tangent (tanh) based activation function, a convolutional activation function, up-sampling, pooling, and a rectified linear unit (ReLU) based activation function.

Various embodiments make use of neural network training methods as described above to generate one or more LLMs that are trained or fine-tuned to generate project requirements management documents as described herein. In various embodiments, LLMs may be trained or fine-tuned using specialized training datasets to provide the models with the ability to automate the generation of project requirements management documents, such as elicitation questions, user stories, acceptance criteria, process flow diagrams, and functional test cases. The training process involves applying datasets that include input documents, such as business requirements, as-is process flows, use cases and their corresponding correct outputs, such as refined elicitation questions, finalized user stories, and other project deliverables. By using supervised learning techniques, the model's parameters are adjusted iteratively to minimize the error between the model-generated outputs and the expected outputs in the training data as described with reference to FIG. 2C.

To achieve this, a training dataset may be created for each type of output artifact. For example, a dataset for training the model to generate elicitation questions may include examples of business requirement documents paired with manually generated or refined elicitation questions. Similarly, datasets for user stories and acceptance criteria may include inputs of elicitation questions and answers, with outputs being expertly crafted user stories and acceptance criteria adhering to the INVEST (independent, negotiable, valuable, small, testable) principles for writing effective user stories and SMART (specific, measurable, achievable, relevant, time-bound) principles for writing acceptance criteria in Agile project requirements management. Process flow diagrams may be represented in the training data as BPMN (business process model and notation) 2.0-compliant text annotations or standardized XML notations paired with corresponding input requirements. Functional test cases may be included as outputs linked to specific user stories and acceptance criteria, illustrating traceability.

In some embodiments, the computing system may use a single LLM trained or fine-tuned across multiple datasets to generate all types of artifacts.

On the other hand, in some embodiments, the computing system may utilize separate LLMs, each specially trained or fine-tuned for a specific type of document generation. For instance, a first LLM may be trained exclusively on datasets for generating elicitation questions, while a second LLM may be trained or fine-tuned to produce to-be process flow diagrams, and a third LLM may be trained or fine-tuned to produce functional test cases. Alternatively, a multi-task learning approach may be used, in which a single LLM is trained with a diverse dataset encompassing all input-output document pairs for the various project requirements management documents. In such single-LLM embodiments, the LLM may dynamically adjust its output document based on the type of input on which it has been trained.

Fine-tuning may further enhance an LLM's performance for generating particular types of project requirements management documents for different technologies and industries. For example, training datasets can be tailored to domain-specific language, standards, and practices, such as software development, healthcare, or manufacturing. This domain-specific fine-tuning enables the model or models to provide outputs that are more relevant and accurate for specialized use cases, improving their applicability and value to project requirements management teams.

FIG. 3 illustrates a block diagram of a computing system 300 configured to implement the processes of the present invention. The computing system 300 includes a processing system 310 that orchestrates various AI LLMs, interfaces, and interactions with external data repositories. The computing system 300 enables the automation of project requirements management initiation and planning processes, leveraging large language models (LLMs) and external storage units for data handling and generation of deliverables. Additionally, the computing system 300 incorporates a user interface via which analysts can provide inputs and receive outputs from the system.

A processing system 310 forms the core of the computing system 300, implementing one or more AI LLMs trained for specific functions within the automated workflow. As described above, in some embodiments, the computing system may include multiple LLMs that are each specially trained or fine-tuned to produce a particular set of documents in response to a given input, such as output elicitation questions based on inputs of project requirements. In some embodiments, the computing system may include an overall LLM that has been trained to receive the various inputs described herein and output the various project documents. FIG. 3 illustrates such AI capabilities as separate LLMs for purposes of efficient description. However, it should be understood that the inference capabilities of the separately described LLMs may be implemented within a single overall LLM to appropriate training or fine-tuning. The LLMs or LLM inference capabilities include: an Elicitation Question LLM Model 314, which generates and refines elicitation questions based on received business requirements; an Epics and User Stories LLM Model 316, which produces draft user stories aligned with project objectives; an Acceptance Criteria LLM Model 318, which generates criteria compliant with INVEST and SMART principles; a Requirement-to-Process Flow LLM Model 320, which creates BPMN 2.0-compliant process flow diagrams; and a Test Cases LLM Model 322, which generates functional test cases with traceability to finalized user stories and acceptance criteria.

The computing system 300 may interface with several external memory blocks for data storage and retrieval. These may include: general working memory 302; a requirements repository 304, which stores input business requirements; a project requirements management system 306, which serves as a platform for uploading finalized user stories and associated artifacts; and a project requirements management documents repository 308, which maintains various project artifacts for traceability and compliance. Additionally, the computing system may access the project requirements management documents repository 308 to store draft and final versions of various documents, such as to-be process flows and test cases generated by the respective LLMs.

An analyst's computer 330 provides an interactive platform for users to input business requirements, review generated outputs, and provide edits or feedback. This interface allows for data communications between the analyst and the computing system 300, enabling input of documents (e.g., project requirements) and receipt of outputs from the computing system 300.

The document output unit 332 facilitates the preparation and delivery of finalized project requirements management documents, such as to the analyst's computer 330. This unit may consolidate outputs from the various LLMs, ensuring that all deliverables are accurate, traceable, and presented in the required formats for downstream use in project requirements management systems and workflows.

Overall, the computing system 300 exemplifies an AI-enabled platform for automating key project requirements management tasks, leveraging the specialized capabilities of multiple LLMs and integrating with external systems and user interfaces. This architecture ensures efficient, accurate, and adaptive generation of project deliverables, meeting the evolving needs of modern project requirements management practices.

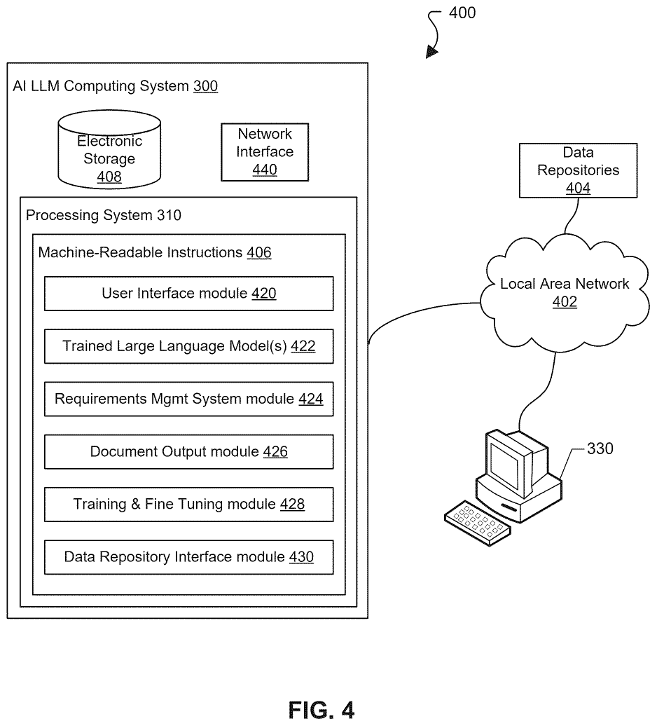

FIG. 4 is a component block diagram illustrating a system 400 for using an AI LLM computing system 300 to develop project requirements management documents in accordance with various embodiments. With reference to FIGS. 1A-4, the system 400 may include an AI LLM computing system 300 that is coupled to an analyst's computer 330 and a data repository 404, such as via a local area network 402. The data repository 404 may be a large database memory, such as a server coupled to large-scale storage on which may be stored enterprise, legal, and standards requirements, as well as project requirements management documents from previous projects, and provide working memory and host the project requirements management system (e.g., a JIRA® or other) files and software, thereby supporting memory modules 302-308 described above with reference to FIG. 3.

The computing system 300 may include a processing system 310, electronic storage 408, and a network interface 440 supporting network communications via the local area network 402.

The processing system 310 may include one or more processors, which may include a neural network processor (e.g., a GPU), that are configured by machine-readable instructions 406, which may be stored in the electronic storage 408. Machine-readable instructions 406 may include one or more instruction modules. The instruction modules may include computer program modules. In some embodiments, the functions of the instruction modules may be implemented in software, firmware, hardware (e.g., circuitry), or a combination of software and hardware, which are configured to perform particular operations or functions. The instruction modules may include one or more of a user interface module 420, one or more trained LLMs 422, a project requirements management system module 424, a documents output module 426, training and fine-tuning module 428, and a data repository interface module 430, as well as other enabling and supporting software modules.

The user interface module 420 may be configured to support the interactions with an analyst, such as receiving documents from and outputting generated documents to the analyst as described with reference to FIGS. 1A-1C.

The one or more trained LLMs 422 may be AI LLMs that are specially trained or fine-tuned as described herein to generate project requirements management documents based on certain input documents received from an analyst. As described, the LLMs or an overall LLM may be trained based on training datasets to output project requirements management documents to the analyst (e.g., via the user interface module 420).

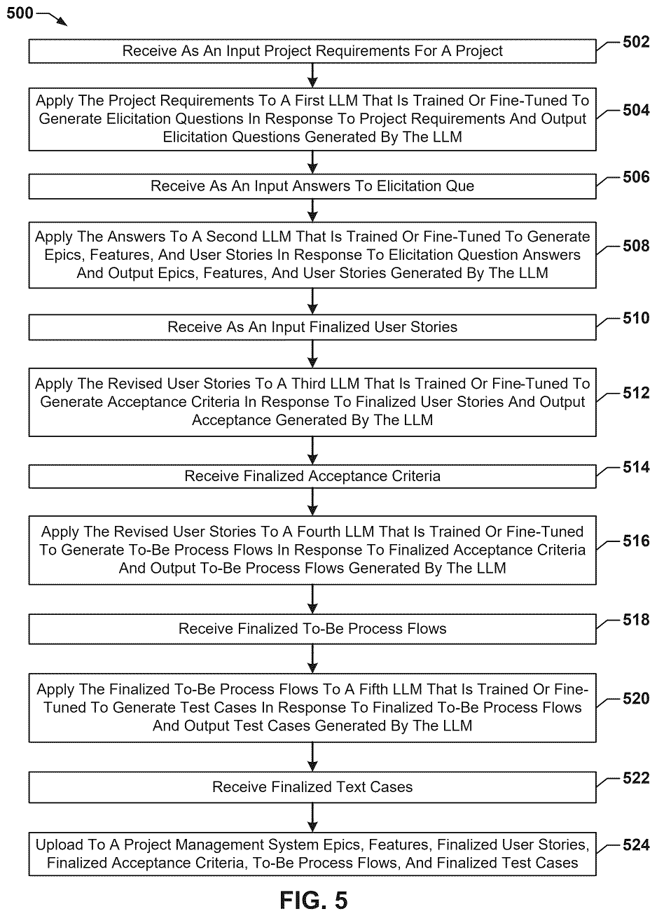

The project requirements management system module 424 may be configured to perform operations associated with transferring project requirements management documents from the computing system 300 to a project requirements management system 306 (see FIG. 3), such as interfacing with a JIRA® system or repository, which may be implemented within the data repository 404. In particular, the project requirements management system module 424 may be configured to interface with an enterprise project requirements management system, including automatically uploading generated project requirements management files as described with reference to FIGS. 1A-1C and 5.

The document output module 426 may be configured to output documents generated by the trained LLM(s) 422 to a computer 330 used by an analyst and/or to memory locations in the data repositories 404.

The training and fine-tuning module 428 may be configured to perform operations associated with initial training, fine-tuning, and adaptive learning of AI LLM modules 422. In training and fine-tuning, the training and fine-tuning module 428 may perform operations supporting the machine learning processes described with reference to FIGS. 2B and 2C. In some embodiments, the training and fine-tuning module 428 may perform operations to enable the AI LLM modules 422 to use adaptive learning processes to learn or fine-tune over time from usage of the computing system on project requirements management planning sessions to improve the generation of documents in response to document inputs.

As shown in FIGS. 1A-1C, the analyst may review documents generated by the computing system and input refined documents into the computing system to prompt the generation of the next set of project requirements management documents. For example, FIG. 1B illustrates that the analyst may refine user stories in block 118 and input the finalized user stories into the computing system in block 120. The input of analyst refined user stories provides feedback to the training and fine-tuning module 428 that can be used in adaptive learning to improve the LLM model or portions of the overall LLM model that generates epics, features, and user stories in block 114 (FIG. 1A) in response to inputs of elicitation outcomes in block 112. As another example, the computing system can use past project requirements management documents stored in a project requirements management documents database 308 (FIG. 3) in adaptive learning or continuous fine-tuning, using initial inputs stored in the database as the training inputs and using the final documents generated by the analyst using the computing system as the truth set for adaptive learning and fine-tuning processes.

The data repository interface module 430 may be configured to support the trained LLM(s) 422 by providing access to or obtaining documents and information from various data repositories 404. For example, in some embodiments, the data repository interface module 430 may provide documents or information on enterprise, legal, and technical standards requirements to one or more trained LLM(s) 422 to support the inference and output of project requirements management documents that depend on such requirements (e.g., acceptance criteria, to-be process flows, and test cases).

The electronic storage 408 may include non-transitory storage media that electronically stores information. The electronic storage media of electronic storage 408 may include one or both system storage that is provided integrally (i.e., substantially non-removable) and/or removable storage that is removably connectable to the processing system 310 (e.g., via a universal serial bus (USB) port, a firewire port, etc.). Electronic storage 408 may include one or more virtual storage resources (e.g., cloud storage, a virtual private network, and/or other virtual storage resources). Electronic storage 408 may store software algorithms, information determined by the processing system(s) 404, documents received from the analyst computer 402, and/or other information that enables the PMA module 120 to function as described herein.

The description of the functionality provided by the different modules 420-430 is for illustrative purposes, and is not intended to be limiting, as any of modules 420-430 may provide more or less functionality than is described. For example, one or more of the modules 420-430 may be eliminated, and some or all of a module's functionality may be provided by other modules. As another example, the processing system(s) 404 may be configured to execute one or more additional modules that may perform some or all of the functionality of the modules 420-430.

FIG. 5 is a process flow diagram illustrating an AI LLM computing system method 500 for generating project requirements management documents according to various embodiments. With reference to FIGS. 1A-5, the method 500 may be performed in a computing system by a processing system encompassing one or more components or subsystems discussed in this application. Means for performing the functions of the operations in method 500 may include a processing system including one or more processors, neural network processors, and other components described herein. Further, one or more processors of a processing system may be configured with software or firmware to perform some or all of the operations of the method 500. To encompass the alternative configurations enabled in various embodiments, the hardware implementing any or all of the method 500 is referred to herein as a “processing system.”

As explained herein and further described below, the method 500 may make use of inference processing by one or more LLMs—or an overall LLM—trained or fine-tuned to generate particular project requirements management documents based on specific input documents. These LLMs may be trained using AI machine learning techniques, such as described with reference to FIGS. 2A-2C, using training data sets of project requirements and other documents correlated to truth sets of properly generated and formatted project documentation. Further, in some embodiments, the processing system may be configured to perform adaptive learning processes on one or more of the LLMs based on usage of the method, enabling the one or more LLMs to improve overtime as well as adapt to changes in overarching requirements, document formats, or management systems.

As described herein, the LLMs trained to generate the project requirements management documentation may be implemented as individual LLMs that are individually trained to generate particular documents or may be implemented as an overall LLM that is trained to generate all of the project requirements management documents described herein. Also, some of the individually described LLMs may be implemented in a single LLM trained to generate more than one type of project requirements management document. Therefore, references to first, second, third, fourth and fifth LLM herein are for ease of reference, using one potential implementation. However, the description of the method 500, and other references individual LLMs is not intended to limit the claims to multiple LLMs unless so recited in a claim.

In block 502, the processing system may perform operations including receiving as an input project requirements for a project. Project requirements, as well as and other inputs to the processing system (e.g., in blocks 506, 510, 514, 518, and 522), may be received via direct uploads (e.g., from an analyst computer 330), accessed from a database or repository (e.g., a requirement repository 304 or data repositories 404), and/or retrieved from a specified system or external source, such as by accessing a URL. In particular, in block 502 the processing system may receive inputs through the direct upload of requirement documents, such as project requirements and objectives, business requirements, and other requirements files, which may be provided in various formats. In some embodiments, the processing system may access requirement documents stored in a database or repository (e.g., 304 or 404), or retrieve such documents from a specified URL, enabling integration with existing project requirements management systems. In some embodiments, the processing system may also access standardized project requirements from a pre-populated database or repository (e.g., 304). Standardized requirements may include commonly used business rules, templates, legal requirements, and system constraints. By combining standardized requirements with project-specific inputs, the LLM AI computing system may ensure that the generated project requirements management documentation is comprehensive, consistent, and tailored to the needs of the project and the enterprise.

In block 504, the processing system may perform operations including applying the project requirements to a first LLM that is trained or fine-tuned to generate elicitation questions in response to project requirements. The processing system may output (e.g., to an analyst's computer 300) elicitation questions generated by the LLM. In some embodiments, the operations in block 504 may include applying both the input project requirements and standardized requirements retrieved from a repository to the first LLM to generate the elicitation questions. In block 504, the first LLM may leverage its natural language processing capabilities and specialized training in project requirements management methodologies to recognize key elements within the input data, including systems, processes, stakeholders, and functional and non-functional requirements. The LLM may also be trained to detect gaps, ambiguities, or inconsistencies in the input data, which may serve as patterns or triggers for generating targeted questions to be answered by the project team during elicitation sessions.

In addition to using AI processing of requirements documents, in some embodiments the processing system may use context-aware algorithms programmed based on examples of high-quality project documentation and elicitation sessions. In some embodiments, the processing system may cross-reference changes in or new requirements with impacted use cases and business rules to identify topics requiring further clarification. For example, if the input requirements specify that modifications will occur in a billing system, the processing system may generate questions addressing the functional and technical details of those changes, such as “What specific fields in the billing system will be updated?” or “Are there any new data validation requirements for the updated process?” Similarly, the processing system algorithms may detect unaddressed dependencies in the business requirements, prompting questions such as “Which other systems interact with the billing system for this process?” Combining both AI inferences and algorithm results, the processing system may also generate questions that address non-functional requirements, such as performance, security, and compliance considerations.

In some embodiments, the processing system may tailor elicitation questions generated by the first LLM to specific systems, business units, or information technology areas based on the content of the received project requirements.

In block 506, the processing system may perform operations including receiving as inputs the answers to the elicitation questions. In some embodiments, the processing system may receive answers to the elicitation questions through a question-and-answer user interface that project team members and stakeholders can use to respond directly to elicitation questions.

In block 508, the processing system may perform operations including applying the answers to a second LLM that is trained or fine-tuned to generate epics, features, and user stories in response to elicitation question answers. The processing system may output (e.g., to an analyst's computer 300) epics, features, and user stories generated by the LLM. The second LLM may be trained or fine-tuned to tokenize and then process the answers to the elicitation questions by mapping words and context to corresponding elicitation questions and analyzing their content to extract information relevant to the posed question and/or the gap or ambiguity that triggered the question. Using natural language processing (NLP) techniques, such as semantic analysis and contextual inference, the second LLM may identify key elements, including actors, actions, outcomes, system-specific details, and dependencies. This extracted information may form the foundation for generating structured project requirements management elements, including epics, features, and user stories.

To generate epics and features, the second LLM training or fine-tuning may enable the model to group related elicitation responses into higher-level categories, reflecting major functionalities or goals of the project. The model may then generate epics that are subdivided into features and user stories by further breaking down the responses into actionable tasks.

The second LLM may be trained or fine-tuned to craft each user story to follow a standardized format, such as “As an [actor], I want to [action] so that [outcome],” ensuring clarity and consistency. For example, if a response indicates that a billing system needs a new validation process for customer data, the computing system might generate a user story such as “As a system administrator, I want to implement a data validation mechanism so that customer information is accurately recorded.” In some embodiments, the second LLM may be trained or fine-tuned to generate the user stories that specify an actor, action, and outcome.

In addition to using AI processing of elicitation responses, in some embodiments, the processing system may use software-defined algorithms programmed to incorporate additional context from the elicitation responses to enrich the user stories, identifying acceptance criteria where possible and specifying details like dependencies, inputs, and outputs. For example, the processing system might append to a user story the requirement that validation must occur in under two seconds or integrate with an external compliance-checking system. As another example, the processing system may be programmed to include traceability information with each user story to enable the stories to be linked to their corresponding elicitation question and project team member or stakeholder response.

In block 510, the processing system may perform operations including receiving as an input finalized user stories, as may be provided by an analyst.

In block 512, the processing system may perform operations including applying the revised user stories to a third LLM that is trained or fine-tuned to generate acceptance criteria in response to finalized user stories. The processing system may output (e.g., to an analyst's computer 300) acceptance criteria generated by the LLM. In some embodiments, the acceptance criteria may define conditions under which the user stories are considered complete. In some embodiments, the third LLM may be trained or fine-tuned to generate acceptance criteria that adhere to at least one of INVEST or SMART principles.

In the operations of block 512, the third LLM may generate acceptance criteria for finalized user stories through training or fine-tuning on Agile project requirements management standards, such as INVEST and SMART principles, and use of natural language processing (NLP) techniques to identify key attributes and conditions that define the successful completion of each user story. The LLM may be trained or fine-tuned to generate acceptance criteria that addresses functional and non-functional requirements while remaining specific, measurable, and testable. The LLM may use NLP processes to evaluate the intent of each user story and identify potential edge cases, dependencies, and performance constraints. In addition, the LLM may be further trained or fine-tuned to incorporate industry-specific requirements or best practices into the acceptance criteria, such as compliance with security standards, scalability considerations, or user experience guidelines. The LLM may be further trained or fine-tuned to generate acceptance criteria that are structured in a clear, consistent format, such as Gherkin-style “Given-When-Then” scenarios, bullet points, or other formats predefined by the analyst or organization.

In some embodiments, the operations in block 512 may include automatically uploading the approved/finalized user stories to a project requirements management system, such as a JIRA® repository, enabling the user stories to be integrated into the project's workflow management system. This automated upload may help to ensure that the development team and other stakeholders have immediate access to the finalized user stories, streamlining collaboration and reducing the risk of manual errors or omissions during the remainder of the process of developing the project requirements management documentation.

In block 514, the processing system may perform operations including receiving finalized acceptance criteria, such as from an analyst's computer.

In block 516, the processing system may perform operations including applying the revised user stories to a fourth LLM that is trained or fine-tuned to generate to-be process flows in response to finalized acceptance criteria. The processing system may output (e.g., to an analyst's computer 300) to-be process flows generated by the LLM. In some embodiments, the fourth LLM may be trained or fine-tuned to generate to-be process flow that comply with BPMN 2.0 standards.

The fourth LLM may be trained or fine-tuned to recognize relationships and dependencies inherent in the acceptance criteria, as well as system requirements, epics, and user stories, to construct process flow diagrams that visually represent the steps and actions required to achieve the project's objectives. LLM training or fine-tuning on software testing principles and Agile methodologies may enable the model to map each step or decision in the to-be process flow to corresponding input conditions, expected outcomes, and validation criteria. The LLM model training may encompass Agile project requirements management principles and process modeling, enabling the LLM inferences to identify key tasks, decisions, and sequences from the inputted user stories and acceptance criteria to generate process flows that comply with industry standards, such as BPMN 2.0. The LLM model may also be trained or fine-tuned to incorporate non-functional requirements and performance expectations specified in the acceptance criteria to ensure comprehensive modeling of the processes.

In some embodiments, the fourth LLM may be trained or fine-tuned on predefined modeling rules regarding presentation of both the logical and temporal order of tasks. For example, the LLM processing may identify task dependencies and parallel workflows from the user stories and map these relationships into process lanes and branches. If a user story specifies interactions between multiple systems, the fourth LLM may allocate these tasks to distinct swimlanes that delineate system responsibilities. The fourth LLM may be trained or fine-tuned to represent decision points, such as conditional logic based on business rules, using standard BPMN symbols like gateways. For example, if a user story involves a billing system with conditional steps based on payment status, the LLM might represent this as a gateway node with two branches: one leading to a reminder notification task and the other to service suspension.

In addition to using AI processing of elicitation responses, in some embodiments, the processing system may use software-defined algorithms programmed to incorporate non-functional requirements and performance criteria into the process flows generated by the LLM. For instance, if a user story specifies that a task must be completed within a specific timeframe, the processing system may append annotations to the process flow regarding timing constraints. Similarly, the processing system may integrate error-handling pathways, such as retry mechanisms or escalation procedures, into the LLM-generated process flows where applicable.

In block 518, the processing system may perform operations including receiving finalized to-be process flows.

In block 520, the processing system may perform operations including applying the finalized to-be process flows to a fifth LLM that is trained or fine-tuned to generate test cases in response to finalized to-be process flows. The processing system may output (e.g., to an analyst's computer 300) test cases generated by the LLM. In some embodiments, the fifth LLM may be trained or fine-tuned to generate test cases that provide a comprehensive set of elements necessary for validating the corresponding processes, including scenarios covering at least positive, negative, and alternate pathways. For example, the test cases generated in block 520 may include a test case identifier, a description of the scenario being tested, preconditions required for the test, detailed step-by-step instructions for executing the test, expected outcomes, and pass/fail criteria. Additionally, the test cases may include references to the specific user stories, epics, or process steps they are validating, ensuring full traceability between project requirements and validation efforts.

The fifth LLM may be trained or fine-tuned on software testing methodologies and to use NLP techniques to identify specific scenarios from the acceptance criteria and map them to corresponding tasks, conditions, and outcomes outlined in the to-be process flows. The training and fine-tuning of the LLM may enable the generated test cases to align with the logical flow and dependencies outlined in the to-be process flows. For example, if a process flow specifies a conditional task based on user input, the LLM may be trained or fine-tuned to generate test cases to validate each potential branch of the decision point. Additionally, the LLM may be trained or fine-tuned to incorporate edge cases in test cases, such as system performance under high loads or unexpected user inputs, to ensure comprehensive testing coverage. Further, the LLM may be trained or fine-tuned to generate test cases structured in a format compatible with manual or automated testing frameworks, which may enable integration into the project's quality assurance processes.

In block 522, the processing system may perform operations including receiving finalized test cases.

In block 524, the processing system may perform operations including automatically uploading the epics, features, finalized user stories, finalized acceptance criteria, to-be process flows, and finalized test cases to a project requirements management system. In some embodiments, the project requirements management system may be or may implement a JIRA® repository.

As part of automatically uploading the project requirements management documents in block 524, the processing system may log the generated documentation with traceability to the input project requirements and include the traceability information in the upload to the project requirements management system. Traceability enables stakeholders to track each element of the project documentation back to its source, enabling comprehensive oversight and validation of project deliverables. By maintaining this hierarchical linkage, the processing system enhances transparency, simplifies audits, and provides a clear lineage of requirements through to implementation and testing. The processing system may embed traceability data within the documents, linking each generated item back to its originating business requirement and associated project artifacts. For example, traceability information may be structured hierarchically, such as:

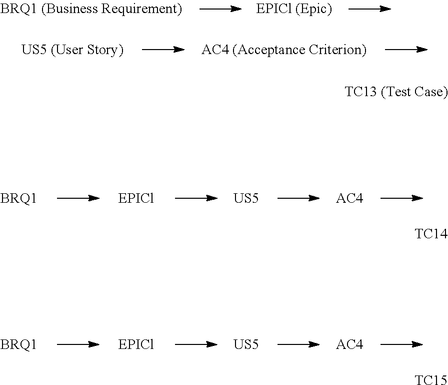

Also, as part of the upload operations in block 524, the processing system may format the output files according to the requirements of the project requirements management system, ensuring compatibility and usability with the system file management processes and user interfaces. For example, documentation may be exported as structured files, such as XML, JSON, or CSV, for easy integration into project requirements management systems like JIRA®.

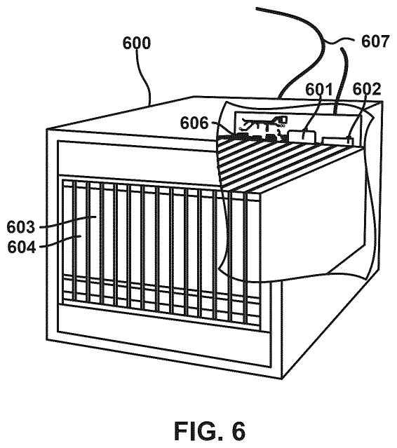

Some embodiments may be implemented on a variety of commercially available computing systems, such as the server computing device 600 illustrated in FIG. 6. The server device 600 may include a multi-core processor 601 coupled to volatile memory 602, such as RAM, and a large capacity nonvolatile memory, such as a solid-state drive 603. The server device 600 may also include additional storage interfaces such as universal serial bus (USB) ports and NVMe slots coupled to the processing system 601. The server device 600 may include network access ports 606 coupled to the processing system 601, enabling data connections through a network interface card 604 and a communication network 607 (e.g., an Internet Protocol (IP) network) connected to other network elements.

Implementation examples are described in the following paragraphs. While some of the following implementation examples are described in terms of example methods, further example implementations may include: the example methods discussed in the following paragraphs implemented by a computing system including a processing system configured (e.g., with processor-executable instructions) to perform operations of the methods of the following implementation examples; and the example methods discussed in the following paragraphs may be implemented as a non-transitory processor-readable storage medium having stored thereon processor-executable instructions configured to cause a processing system of a computing system to perform the operations of the methods of the following implementation examples.

Example 1. A method implemented within a computer processing system for generating project requirements management documentation using an artificial intelligence (AI) large language model (LLM) computing system, the method including: receiving as an input project requirements for a project; applying the project requirements to a first LLM that is trained or fine-tuned to generate elicitation questions in response to project requirements and output elicitation questions generated by the LLM; applying answers to elicitation questions to a second LLM that is trained or fine-tuned to generate epics, features, and user stories in response to elicitation question answers and output epics, features, and user stories generated by the LLM; applying finalized user stories to a third LLM that is trained or fine-tuned to generate acceptance criteria in response to finalized user stories and output acceptance generated by the LLM, the acceptance criteria defining conditions under which the user stories are considered complete; applying finalized acceptance criteria to a fourth LLM that is trained or fine-tuned to generate to-be process flows in response to finalized acceptance criteria and output to-be process flows generated by the LLM; applying finalized to-be process flows to a fifth LLM that is trained or fine-tuned to generate test cases in response to finalized to-be process flows and output test cases generated by the LLM; and automatically uploading to a project requirements management system the epics, features, finalized user stories, finalized acceptance criteria, to-be process flows, and finalized test cases.

Example 2. The method of example 1, in which the input project requirements are received via a direct upload, accessed from a database or repository, or retrieved from a specified URL.

Example 3. The method of either of examples 1 or 2, in which applying the project requirements to a first LLM includes applying both the input project requirements and standardized requirements retrieved from a repository to the first LLM to generate the elicitation questions.

Example 4. The method of any of examples 1-3, in which the second LLM is trained or fine-tuned to generate user stories that specify an actor, action, and outcome.

Example 5. The method of any of examples 1-4, in which the third LLM is trained or fine-tuned to generate acceptance criteria that adhere to at least one of INVEST or SMART principles.

Example 6. The method of any of examples 1-5, in which the fourth LLM is trained or fine-tuned to generate to-be process flow that comply with Business Process Model and Notation (BPMN) 2.0 standards.

Example 7. The method of any of examples 1-6, in which the fifth LLM is trained or fine-tuned to generate test cases that include scenarios covering at least positive, negative, and alternate pathways.

Example 8. The method of any of examples 1-7, in which automatically uploading to a project requirements management system the epics, features, finalized user stories, finalized acceptance criteria, to-be process flows, and finalized test cases includes uploading the documentation to a JIRA® repository.

Example 9. The method of any of examples 1-8, in which the first LLM, second LLM, third LLM, fourth LLM, and fifth LLM are trained inference functionality within a single overall LLM.

Example 10. The method of any of examples 1-9, further including performing adaptive learning processes on one or more of the first LLM, second LLM, third LLM, fourth LLM, and fifth LLM over time based on use of the AI LLM computing system to adapt to changes in project requirements management practices, document formats, or business processes.

Example 11. The method of any of examples 1-10, further including logging generated documentation with traceability to the input project requirements.

As used in this application, terminology such as “unit,” “component,” “module,” “system,” etc., is intended to encompass a software-implemented or computer-related entity. These entities may involve, among other possibilities, hardware, firmware, a blend of hardware and software, software alone, or software in an operational state. As examples, a component may encompass a running process on a processor, the processing system itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function or procedure calls, electronic signaling, data packet exchanges, and memory interactions, among other known methods of network, computer, processor, or process-related communications.

A number of different types of memories and memory technologies are available or contemplated in the future, any or all of which may be included and used in systems and computing devices that implement the various embodiments.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, solid-state drives (SSD), non-volatile memory express (NVMe) drives, or any other medium that may be used to store target program code in the form of instructions or data structures and that may be accessed by a computer. Modern technologies, such as cloud-based storage solutions, including infrastructure-as-a-service (IaaS) platforms, may offer scalable and distributed options for storing and accessing program code.

In addition, the operations of a method or algorithm may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. Artificial intelligence (AI) and machine learning (ML)-optimized hardware accelerators, such as graphical processing systems (GPUs) and tensor processing systems (TPUs), may be used to execute complex algorithms.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for generating project requirements management documentation using an artificial intelligence (AI) large language model (LLM) computing system, the method comprising:
receiving as an input project requirements for a project;
applying the project requirements to a first LLM that is trained or fine-tuned to generate elicitation questions in response to project requirements and output elicitation questions generated by the LLM;
applying answers to elicitation questions to a second LLM that is trained or fine-tuned to generate epics, features, and user stories in response to elicitation question answers and output epics, features, and user stories generated by the LLM;
applying finalized user stories to a third LLM that is trained or fine-tuned to generate acceptance criteria in response to finalized user stories and output acceptance generated by the LLM, the acceptance criteria defining conditions under which the user stories are considered complete;
applying finalized acceptance criteria to a fourth LLM that is trained or fine-tuned to generate to-be process flows in response to finalized acceptance criteria and output to-be process flows generated by the LLM;
applying finalized to-be process flows to a fifth LLM that is trained or fine-tuned to generate test cases in response to finalized to-be process flows and output test cases generated by the LLM; and
automatically uploading to a project requirements management system the epics, features, finalized user stories, finalized acceptance criteria, to-be process flows, and finalized test cases.

2. The method of claim 1, wherein the input project requirements are received via a direct upload, accessed from a database or repository, or retrieved from a specified URL.

3. The method of claim 1, wherein applying the project requirements to a first LLM comprises applying both the input project requirements and standardized requirements retrieved from a repository to the first LLM to generate the elicitation questions.

4. The method of claim 1, wherein the second LLM is trained or fine-tuned to generate user stories that specify an actor, action, and outcome.

5. The method of claim 1, wherein the third LLM is trained or fine-tuned to generate acceptance criteria that adhere to at least one of INVEST or SMART principles.

6. The method of claim 1, wherein the fourth LLM is trained or fine-tuned to generate to-be process flow that comply with Business Process Model and Notation (BPMN) 2.0 standards.

7. The method of claim 1, wherein the fifth LLM is trained or fine-tuned to generate test cases that include scenarios covering at least positive, negative, and alternate pathways.

8. The method of claim 1, wherein automatically uploading to a project requirements management system the epics, features, finalized user stories, finalized acceptance criteria, to-be process flows, and finalized test cases comprises uploading the documentation to a JIRA® repository.

9. The method of claim 1, wherein the first LLM, second LLM, third LLM, fourth LLM, and fifth LLM are trained inference functionality within a single overall LLM.

10. The method of claim 1, further comprising performing adaptive learning processes on one or more of the first LLM, second LLM, third LLM, fourth LLM, and fifth LLM over time based on use of the AI LLM computing system to adapt to changes in project requirements management practices, document formats, or business processes.

11. The method of claim 1, further comprising logging generated documentation with traceability to the input project requirements.

12. A computing system, comprising:
a memory;
a network interface; and
a processing system coupled to the memory and network interface, and configured with processor-executable instructions to perform operations comprising:
receiving as an input project requirements for a project;
applying the project requirements to a first large language model (LLM) that is trained or fine-tuned to generate elicitation questions in response to project requirements and output elicitation questions generated by the LLM;
applying answers to elicitation questions to a second LLM that is trained or fine-tuned to generate epics, features, and user stories in response to elicitation question answers and output epics, features, and user stories generated by the LLM;
applying finalized user stories to a third LLM that is trained or fine-tuned to generate acceptance criteria in response to finalized user stories and output acceptance generated by the LLM, the acceptance criteria defining conditions under which the user stories are considered complete;
applying finalized acceptance criteria to a fourth LLM that is trained or fine-tuned to generate to-be process flows in response to finalized acceptance criteria and output to-be process flows generated by the LLM;
applying finalized to-be process flows to a fifth LLM that is trained or fine-tuned to generate test cases in response to finalized to-be process flows and output test cases generated by the LLM; and
automatically uploading to a project requirements management system the epics, features, finalized user stories, finalized acceptance criteria, to-be process flows, and finalized test cases.

13. The computing system of claim 12, wherein the input project requirements are received via a direct upload, accessed from a database or repository, or retrieved from a specified URL.

14. The computing system of claim 12, wherein applying the project requirements to a first LLM comprises applying both the input project requirements and standardized requirements retrieved from a repository to the first LLM to generate the elicitation questions.

15. The computing system of claim 12, wherein the second LLM is trained or fine-tuned to generate user stories that specify an actor, action, and outcome.

16. The computing system of claim 12, wherein the third LLM is trained or fine-tuned to generate acceptance criteria that adhere to at least one of INVEST or SMART principles.

17. The computing system of claim 12, wherein the fourth LLM is trained or fine-tuned to generate to-be process flow that comply with Business Process Model and Notation (BPMN) 2.0 standards.

18. The computing system of claim 12, wherein the fifth LLM is trained or fine-tuned to generate test cases that include scenarios covering at least positive, negative, and alternate pathways.

19. The computing system of claim 12, wherein automatically uploading to a project requirements management system the epics, features, finalized user stories, finalized acceptance criteria, to-be process flows, and finalized test cases comprises uploading the documentation to a JIRA® repository.

20. The computing system of claim 12, wherein the first LLM, second LLM, third LLM, fourth LLM, and fifth LLM are trained inference functionality within a single overall LLM.

21. The computing system of claim 12, further comprising performing adaptive learning processes on one or more of the first LLM, second LLM, third LLM, fourth LLM, and fifth LLM over time based on use of the AI LLM computing system to adapt to changes in project requirements management practices, document formats, or business processes.

22. The computing system of claim 12, further comprising logging generated documentation with traceability to the input project requirements.

23. A non-transitory processor-readable medium having stored thereon processor-executable instructions configured to cause a processing system of a computing system to perform operations comprising:
receiving as an input project requirements for a project;
applying the project requirements to a first large language model (LLM) that is trained or fine-tuned to generate elicitation questions in response to project requirements and output elicitation questions generated by the LLM;
applying answers to elicitation questions to a second LLM that is trained or fine-tuned to generate epics, features, and user stories in response to elicitation question answers and output epics, features, and user stories generated by the LLM;
applying finalized user stories to a third LLM that is trained or fine-tuned to generate acceptance criteria in response to finalized user stories and output acceptance generated by the LLM, the acceptance criteria defining conditions under which the user stories are considered complete;
applying finalized acceptance criteria to a fourth LLM that is trained or fine-tuned to generate to-be process flows in response to finalized acceptance criteria and output to-be process flows generated by the LLM;
applying finalized to-be process flows to a fifth LLM that is trained or fine-tuned to generate test cases in response to finalized to-be process flows and output test cases generated by the LLM; and
automatically uploading to a project requirements management system the epics, features, finalized user stories, finalized acceptance criteria, to-be process flows, and finalized test cases.

24. The non-transitory processor-readable medium of claim 23, wherein the stored processor-executable instructions are further configured to cause the processing system of the computing system to perform operations comprising receiving the input project requirements via a direct upload, accessed from a database or repository, or retrieved from a specified URL.

25. The non-transitory processor-readable medium of claim 23, wherein the stored processor-executable instructions are further configured to cause the processing system of the computing system to perform operations such that applying the project requirements to a first LLM comprises applying both the input project requirements and standardized requirements retrieved from a repository to the first LLM to generate the elicitation questions.

26. The non-transitory processor-readable medium of claim 23, wherein the second LLM is trained or fine-tuned to generate user stories that specify an actor, action, and outcome.

27. The non-transitory processor-readable medium of claim 23, wherein the third LLM is trained or fine-tuned to generate acceptance criteria that adhere to at least one of INVEST or SMART principles.

28. The non-transitory processor-readable medium of claim 23, wherein the fourth LLM is trained or fine-tuned to generate to-be process flow that comply with Business Process Model and Notation (BPMN) 2.0 standards.

29. The non-transitory processor-readable medium of claim 23, wherein the fifth LLM is trained or fine-tuned to generate test cases that include scenarios covering at least positive, negative, and alternate pathways.

30. The non-transitory processor-readable medium of claim 23, wherein the stored processor-executable instructions are further configured to cause the processing system of the computing system to perform operations such that automatically uploading to a project requirements management system the epics, features, finalized user stories, finalized acceptance criteria, to-be process flows, and finalized test cases comprises uploading the documentation to a JIRA® repository.

31. The non-transitory processor-readable medium of claim 23, wherein the first LLM, second LLM, third LLM, fourth LLM, and fifth LLM are trained inference functionality within a single overall LLM.

32. The non-transitory processor-readable medium of claim 23, wherein the stored processor-executable instructions are further configured to cause the processing system of the computing system to perform operations further comprising performing adaptive learning processes on one or more of the first LLM, second LLM, third LLM, fourth LLM, and fifth LLM over time based on use of the AI LLM computing system to adapt to changes in project requirements management practices, document formats, or business processes.

33. The non-transitory processor-readable medium of claim 23, wherein the stored processor-executable instructions are further configured to cause the processing system of the computing system to perform operations further comprising logging generated documentation with traceability to the input project requirements.
